(19) United States
(12) Patent Application Publication
(10) Pub. No.: US 2025/0167219 A1
(43) Pub. Date: May 22, 2025

(54) METHOD TO CONVERT LITHIUM CARBONATE LAYER ON THE SURFACE OF BATTERY CATHODES TO BENEFICIAL COATING LAYERS

(71) Applicant: UCHICAGO ARGONNE, LLC, Chicago, IL (US)

(72) Inventors: Donghyeon Kang, Willowbrook, IL (US); Anil U. Mane, Naperville, IL (US); Jeffrey W. Elam, Elmhurst, IL (US)

(73) Assignee: UCHICAGO ARGONNE, LLC, Chicago, IL (US)

(21) Appl. No.: 18/744,373

(22) Filed: Jun. 14, 2024

Related U.S. Application Data
(60) Provisional application No. 63/521,589, filed on Jun. 16, 2023.

(51) Int. Cl. H01M 4/36; C01G 53/506; H01M 4/525

(52) U.S. Cl. CPC H01M 4/366; C01G 53/506; H01M 4/525; C01P 2002/50; C01P 2002/82; C01P 2002/85; C01P 2006/40

(57) ABSTRACT

A method of modifying a battery cathode material includes the steps of heating the battery cathode material to a temperature of about 250° C. to about 350° C.; while heating, exposing the battery cathode material to an organometallic gas; and purging the organometallic gas from the battery cathode material, wherein the method removes lithium carbonate from the cathode material surface.

### CROSS-REFERENCE TO RELATED APPLICATIONS

The application claims the benefit of and priority to U.S. Provisional Patent Application No. 63/521,589, filed Jun. 16, 2023, entitled “METHOD TO CONVERT LITHIUM CARBONATE LAYER ON THE SURFACE OF BATTERY CATHODES TO BENEFICIAL COATING LAYERS”, which is incorporated by reference herein in its entirety for any and all purposes.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present technology is generally related to rechargeable batteries, and more specifically is related to battery cathode materials and methods of making battery cathode materials that substantially lack carbonate impurities.

### BACKGROUND

Lithium ion (“Li-ion”) batteries have become a dominant player in the energy storage market. However, lithium-ion battery cathode materials typically include a lithium carbonate (Li₂CO₃) impurity layer on the cathode material surface resulting from interaction with air. Since it is not conductive to lithium ions, the Li₂CO₃ layer may increase the battery's resistance and overpotential during electrochemical cycling. Furthermore, during the initial electrochemical cycles, the Li₂CO₃ layer may decompose and release CO₂ gas, thereby necessitating a degassing step as part of battery manufacturing processes.

Removal of the Li₂CO₃ layer on the surface of battery cathode materials is highly desirable. Conventionally, the Li₂CO₃ layer may be removed during battery manufacturing by washing the cathode material with water. However, this washing step does not prevent the re-formation of the Li₂CO₃ layer on the cathode material surface after the washing step.

### SUMMARY

Embodiments described herein relate generally to methods to convert the undesired Li₂CO₃ layer on lithium-ion cathode materials into ionically conductive Li-metal-oxide (Li-M-O) layers via a chemical vapor transformation (CVT) process, the cathode materials resulting from this conversion method, and batteries including these cathode materials. Batteries with cathodes modified with CVT demonstrated improved battery cycling performance.

In one aspect, a method of modifying a battery cathode material is disclosed. The method comprises heating the battery cathode material to a temperature of about 250° C. to about 350° C.; while heating, exposing the battery cathode material to an organometallic gas; and purging the organometallic gas from the battery cathode material. Exposing the battery cathode material to the organometallic gas may include converting the lithium carbonate to a lithium metal oxide.

The battery cathode material may comprise lithium carbonate prior to exposing the battery cathode material to the organometallic gas and the battery cathode material may not comprise lithium carbonate after exposing the battery cathode material to the organometallic gas. Exposing the battery cathode material to the organometallic gas may include exposing the battery cathode material to the organometallic gas for about 1 minute to about 5 minutes. Exposing the battery cathode material to the organometallic gas may include exposing the battery cathode material to the organometallic gas for about 2 minutes.

The organometallic gas may comprise an organoaluminum gas, an organoindium gas, an organogallium gas, an organozinc gas, an organocadmium gas, an organoniobium gas, an organotungsten gas, an organomolybdenum gas, an organotitanium gas, or a mixture of two or more thereof. The organoaluminum gas may comprise trimethylaluminum (TMA). The organoindium gas may comprise trimethylindium.

The battery cathode material may comprise lithium cobalt oxide, lithium nickel manganese cobalt oxide, lithium nickel oxide, or a mixture thereof. The battery cathode material may be a powder. The method may not comprise exposing the battery cathode material to any co-reactant gas.

In one aspect, a battery cathode material having a conformal layer of lithium metal oxide on a surface of the battery cathode material is disclosed. The battery cathode material may not comprise lithium carbonate. The battery cathode material may be made by the CVT process. The CVT process may include heating the battery cathode material to a temperature of about 250° C. to about 350° C.; while heating, exposing the battery cathode material to an organometallic gas; and purging the organometallic gas from the battery cathode material.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are not, therefore, to be considered limiting of its scope, the disclosure will be described with additional specificity and detail through use of the accompanying drawings.

FIG. 1 is a schematic of a method of modifying battery cathode materials by converting a Li₂CO₃ layer to a Li-M-O layer on the battery cathode material surface using a CVT process.

FIG. 2A is a graph of X-ray photoelectron spectroscopy (XPS) spectra showing the C-1s peak and FIG. 2B is a graph of XPS spectra showing the Al-2p peak of nickel-rich layered oxide LiNi_{0.8}Mn_{0.1}Co_{0.1}O₂ (NMC 811) modified with the CVT process as compared to bare NMC 811 and NMC 811 coated with 4 cycles of Al₂O₃ atomic layer deposition (ALD).

FIG. 3A is a graph of X-ray photoelectron spectroscopy (XPS) spectra showing the C-1s peak and FIG. 3B is a graph of XPS spectra showing the Al-2p peak of nickel-rich layered oxide LiNi_{0.8}Mn_{0.1}Co_{0.1}O₂ (NMC 811) modified by the CVT process with different gaseous aluminum precursors as compared to bare NMC 811.

FIG. 4A is a graph of X-ray photoelectron spectroscopy (XPS) spectra showing the C-1s peak and FIG. 4B is a graph of XPS spectra showing the Al-2p peak of nickel-rich layered oxide LiNi_{0.8}Mn_{0.1}Co_{0.1}O₂ (NMC 811) modified by the CVT process with different trimethylaluminum precursor at different temperatures as compared to bare NMC 811.

FIG. 5A is a graph of Fourier-transformed infrared (FTIR) difference spectra of NMC 811 modified with the CVT process using different TMA exposure times. FIG. 5B is a graph of FTIR difference spectra of NMC 811 modified by CVT with 90 seconds of TMA as compared to a Li₂CO₃ reference.

FIG. 6A is a graph of battery cycling of a NMC 811 cathode modified with the CVT process as compared to a bare, unmodified NMC811 cathode and an NMC 811 cathode coated with 4 cycles of Al₂O₃ ALD. FIG. 6B is a graph of battery cycling of a lithium nickel oxide (LNO) cathode modified with the CVT process as compared to a bare, unmodified LNO cathode. FIG. 6C is a graph of battery cycling of a lithium iron phosphate (LFP) cathode modified with the CVT process as compared to a bare, unmodified LFP cathode.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments, and does not pose a limitation on the scope of the claims unless otherwise stated. No language in the specification should be construed as indicating any non-claimed element as essential.

Disclosed herein are materials and constructs such as cathodes and cathode materials for lithium-ion batteries, and methods of modifying such cathodes and cathode materials. Such materials exhibit a surface layer of ionically conductive Li-metal-oxide (Li-M-O) and a substantially small amount of or absence of a Li₂CO₃ layer at the material surface of the cathode material. The Li-M-O layer may be uniformly and/or conformally formed on the surface of the cathode material. The Li-M-O layer may be stable when exposed to air to prevent reformation of the Li₂CO₃ layer following modification.

The methods of modifying cathode materials include exposing a cathode material to a reactive organometallic precursor gas at an elevated temperature to convert the Li₂CO₃ layer on the surface of the cathode material to a Li-M-O layer on the surface of the cathode material. These methods can be used to enhance the stabilization of cathode material surfaces against the effects of unwanted surface reactions that lead to formation of Li₂CO₃ commonly found on certain lithium-ion cathodes, especially when exposed to air. These methods are sometimes called chemical vapor transformation (CVT).

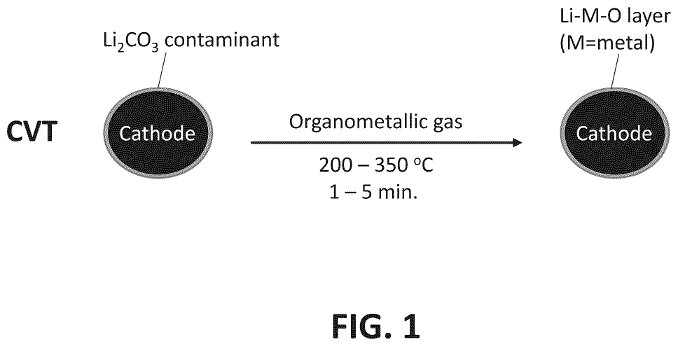

FIG. 1 is a schematic of a method of modifying battery cathode materials via CVT. CVT converts the Li₂CO₃ layer to a Li-M-O layer. The CVT process may include a single step of exposing the cathode material to the organometallic precursor gas. The organometallic precursor gas may selectively react with Li₂CO₃ on the surface of the cathode material to convert the Li₂CO₃ to a Li-M-O layer. Without being bound by any theory, the organometallic precursor gas may react with lithium and/or oxygen atoms in the Li₂CO₃ to form bonds between the M and lithium and/or oxygen atoms, and producing gaseous carbon species, thereby converting the Li₂CO₃ to Li-M-O species. The reaction may be self-limiting, meaning that the organometallic precursor gas substantially stops reacting with the cathode material when the Li₂CO₃ on the cathode material surface has been converted. The CVT process is temperature dependent and the conversion reaction from Li₂CO₃ to Li-M-O with the organometallic precursor may only occur in a narrow, elevated temperature range.

Conventional surface coating techniques include atomic layer deposition (ALD). Generally, ALD is a process to deposit a metal or metal oxide coating on a surface via two separate half-reactions conducted at temperatures of about 100° C. to about 200° C. under vacuum. The first half-reaction may include exposing the surface to an organometallic precursor vapor pulse, where the organometallic precursor reacts with surface species in a self-limiting fashion. The excess first precursor is purged before the second half-reaction. The second half-reaction may include exposing the surface to a second precursor (or co-reactant) vapor pulse that reacts with adsorbed species on the surface formed by the organometallic precursor in a self-limiting fashion. The excess second precursor is then purged. These two half-reactions constitute a single ALD cycle, and can be repeated a number of times to deposit an ALD coating with a desired thickness. As an example, ALD may deposit an Al₂O₃ coating on a surface using trimethylaluminum (TMA) and water. In the first half reaction, the surface is exposed to TMA (e.g., for 5 seconds of precursor exposure), where the TMA reacts with the surface to form organoaluminum surface species and/or TMA adsorbs on the surface. In the second half reaction, the surface is exposed to water (e.g., for 1 second), where the water reacts with the surface organoaluminum species to form Al₂O₃.

The CVT process is distinct from ALD in several ways. ALD typically requires at least two different precursors to deposit a coating, while CVT may use a single gas precursor or mixture of precursor gases. That is, CVT does not use any co-reactant. ALD is less temperature dependent, and is typically conducted at temperatures less than 200° C. In contrast, CVT is highly temperature dependent and may be conducted at temperatures of 250° C. or greater, or 300° C. or greater. ALD typically may not change Li₂CO₃ surface species, while CVT may convert Li₂CO₃ surface species to Li-M-O. The thickness of the ALD coating is determined based on the number of ALD cycles. In contrast, CVT reactions are self-limiting based on the amount of Li₂CO₃ at the surface, and cease once all of the Li₂CO₃ is converted to a thin layer of Li-M-O. In this way, CVT limits the thickness of the Li-M-O layer. Thus, CVT is a preferable cathode surface modification technique over conventional ALD for removing Li₂CO₃.

The CVT reaction may be conducted in a sealed reactor heated to an elevate temperature and under a pressure lower than atmospheric pressure. The pressure within the reactor may be within the range of 0.01 Torr to 10 Torr (e.g., 0.01, 0.05, 0.1, 0.5, 1.0, 5.0, or 10 Torr, inclusive of all ranges and values therebetween), in a flowing or static inert gas (e.g., N₂ or Ar) atmosphere, or substantially to vacuum.

The CVT reaction may be conducted at an elevated temperature. The cathode material may be heated to the elevated temperature using any appropriate heating method (e.g., resistive heating) prior to conducting the CVT reaction. The elevated temperature may be higher than temperatures typically used for ALD and/or lower than temperatures at which the organometallic precursor gas substantially decomposes. The elevated temperature may be about 250° C. to about 350° C. For example, the elevated temperature may be about 250° C., 300° C., 320° C., 340° C., or 350° C., inclusive of all ranges and values therebetween. In some embodiments, the temperature may be about 300° C. to about 350° C. The temperature impacts the overall energy in the system and the performance for diffusion and/or reaction.

The organometallic precursor may be an organoaluminum gas, an organoindium gas, an organogallium gas, an organozinc gas, an organocadmium gas, an organoniobium gas, an organotungsten gas, an organomolybdenum gas, an organotitanium gas, or a mixture of two or more thereof. The CVT precursor may be selected from the precursors noted below in Table 1. Alkyl ligands (e.g., methyl, ethyl, propyl, etc.) are effective in the CVT process. In contrast, alkoxy ligands such as isopropoxy, alkylamido ligands such as dimethylamido, and halogen ligands are not effective in the CVT process. Precursors having larger alkyl ligands (e.g., tert-butyl) generally have lower vapor pressures compared to precursors with smaller alkyl ligands (e.g., methyl) and so will require longer CVT processing times relative to precursors with smaller alkyl ligands.

TABLE 1

| | Metal | | |
|---|---|---|---|
| Ligand | Aluminum | Gallium | Indium |
| methyl: CH₃ | Al(CH₃)₃ | Ga(CH₃)₃ | In(CH₃)₃ |
| ethyl: CH₂CH₃ | Al(CH₂CH₃)₃ | Ga(CH₂CH₃)₃ | In(CH₂CH₃)₃ |
| propyl: | Al(CH₂CH₂CH₃)₃ | Ga(CH₂CH₂CH₃)₃ | In(CH₂CH₂CH₃)₃ |
| CH₂CH₂CH₃ | | | |
| isopropyl: | Al(CH(CH₃)₂)₃ | Ga(CH(CH₃)₂)₃ | In(CH(CH₃)₂)₃ |
| CH(CH₃)₂ | | | |
| butyl: | Al(CH₂CH₂CH₂CH₃)₃ | Ga(CH₂CH₂CH₂CH₃)₃ | In(CH₂CH₂CH₂CH₃)₃ |
| CH₂CH₂CH₂CH₃ | | | |
| isobutyl: | Al(CH₂CH(CH₃)₂)₃ | Ga(CH₂CH(CH₃)₂)₃ | In(CH₂CH(CH₃)₂)₃ |
| CH₂CH(CH₃)₂ | | | |
| tert-butyl: | Al(C(CH₃)₃)₃ | Ga(C(CH₃)₃)₃ | In(C(CH₃)₃)₃ |
| C(CH₃)₃ | | | |
| | Metal | | |
| Ligand | Zinc | Cadmium | Niobium |
| methyl: CH₃ | Zn(CH₃)₃ | Cd(CH₃)₂ | NbCH₃ |
| ethyl: CH₂CH₃ | Zn(CH₂CH₃)₂ | Cd(CH₂CH₃)₂ | NbCH₂CH₃ |
| propyl: | Zn(CH₂CH₂CH₃)₂ | Cd(CH₂CH₂CH₃)₂ | NbCH₂CH₂CH₃ |
| CH₂CH₂CH₃ | | | |
| isopropyl: | Zn(CH(CH₃)₂)₂ | Cd(CH(CH₃)₂)₂ | NbCH(CH₃)₂ |
| CH(CH₃)₂ | | | |
| butyl: | Zn(CH₂CH₂CH₂CH₃)₂ | Cd(CH₂CH₂CH₂CH₃)₂ | NbCH₂CH₂CH₂CH₃ |
| CH₂CH₂CH₂CH₃ | | | |
| isobutyl: | Zn(CH₂CH(CH₃)₂)₂ | Cd(CH₂CH(CH₃)₂)₂ | NbCH₂CH(CH₃)₂ |
| CH₂CH(CH₃)₂ | | | |
| tert-butyl: | Zn(C(CH₃)₃)₂ | Cd(C(CH₃)₃)₂ | NbC(CH₃)₃ |
| C(CH₃)₃ | | | |
| | Metal | | |
| Ligand | Tungsten | Molybdenum | Titanium |
| methyl: CH₃ | W(CH₃)₆ | Mo(CH₃)₅ | Ti(CH₃)₄ |
| ethyl: CH₂CH₃ | W(CH₂CH₃)₆ | Mo(CH₂CH₃)₅ | Ti(CH₂CH₃)₄ |
| propyl: | W(CH₂CH₂CH₃)₆ | Mo(CH₂CH₂CH₃)₅ | Ti(CH₂CH₂CH₃)₄ |
| CH₂CH₂CH₃ | | | |
| isopropyl: | W(CH(CH₃)₂)₆ | Mo(CH(CH₃)₂)₅ | Ti(CH(CH₃)₂)₄ |
| CH(CH₃)₂ | | | |
| butyl: | W(CH₂CH₂CH₂CH₃)₆ | Mo(CH₂CH₂CH₂CH₃)₅ | Ti(CH₂CH₂CH₂CH₃)₄ |
| CH₂CH₂CH₂CH₃ | | | |
| isobutyl: | W(CH₂CH(CH₃)₂)₆ | Mo(CH₂CH(CH₃)₂)₅ | Ti(CH₂CH(CH₃)₂)₄ |
| CH₂CH(CH₃)₂ | | | |
| tert-butyl: | W(C(CH₃)₃)₆ | Mo(C(CH₃)₃)₅ | Ti(C(CH₃)₃)₄ |
| C(CH₃)₃ | | | |

For example, the organoaluminum gas may include TMA and the organoindium gas may include trimethylindium. In some embodiments, the organometallic precursor gas is preferably TMA, and the TMA converts Li₂CO₃ to a conformal layer of lithium aluminate. The conformal layer of lithium aluminate may have a thickness of about 0.1 nm to about 10 nm (e.g., 0.1 nm, 0.2 nm, 0.3 nm, 0.4 nm, 0.5 nm, 0.6 nm, 0.7 nm, 0.8 nm, 0.9 nm, 1 nm, 2 nm, 3 nm, 4 nm, 5 nm, 6 nm, 7 nm, 8 nm, 9 nm, or 10 nm). For example, the conformal layer may be a monolayer.

The organometallic precursor gas exposure time and partial pressure may be selected based on the surface area of the cathode material. For example, the exposure time may be in the range of 0.5 seconds to 500 seconds (e.g., 0.5, 1, 5, 10, 20, 30, 40, 50, 60, 70, 80, 90, 100, 120, 140, 160, 180, 200, 220, 240, 260, 280, 300, 350, 400, 450 or 500 seconds, inclusive of all ranges and values therebetween). In some embodiments, the exposure time is in the range of 60 second to 300 seconds (e.g., about 120 seconds). The partial pressure of the organometallic precursor can be in the range of 0.01 Torr to 10 Torr (e.g., 0.01, 0.05, 0.1, 0.5, 1.0, 5.0, or 10 Torr, inclusive of all ranges and values therebetween). In some embodiments, the partial pressure of the organometallic precursor is in the range of 0.1 Torr and 1 Torr (e.g., about 0.5 Torr). In some embodiments, a single pulse of organometallic precursor gas is used. In other embodiments, a series of organometallic precursor gas pulses are used to deliver a sufficient amount of the precursor gas into the reactor. In some embodiments, a carrier gas (e.g., N₂ or Ar) is flowed through the reactor during the precursor gas exposure step, and in some embodiments no carrier gas is flowed through the reactor during the precursor gas exposure step.

Following organometallic precursor gas exposure, any unreacted precursor is evacuated from the reactor in a purge step. The purge step may include evacuating the precursor gas for a period of 0.5 seconds to about 500 seconds (e.g., 0.5, 1, 5, 10, 20, 30, 40, 50, 60, 70, 80, 90, 100, 120, 140, 160, 180, 200, 220, 240, 260, 280, 300, 350, 400, 450 or 500 seconds, inclusive of all ranges and values therebetween). The precursor purge may reduce the pressure in the reactor to within the range of 0.01 Torr to 10 Torr (e.g., 0.01, 0.05, 0.1, 0.5, 1.0, 5.0, or 10 Torr, inclusive of all ranges and values therebetween), such as substantially to vacuum. In some embodiments, a carrier gas (e.g., N₂ or Ar) is flowed through the reactor during the purge step, and in some embodiments no carrier gas is flowed through the reactor during the purge step.

The battery cathode material may be any layered active cathode material and/or a cathode material containing nickel. Layered active cathode materials typically have greater amounts of Li₂CO₃ surface impurity than active cathode materials having other crystal structures. Similarly, active cathode materials containing nickel tend to have greater amounts of Li₂CO₃ surface impurity than active cathode materials without nickel. Thus, cathodes with layered or nickel-containing materials are good candidates for CVT to remove the Li₂CO₃.

Illustrative layered and/or nickel-containing cathode active materials may include, but are not limited to LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, Li_{1+x″}Ni_{α}Mn_{β}CO_{γ}M⁵_{δ′}O_{2-z″}F_{z″}, or any combination of two or more thereof. In the cathode active materials, M⁵ is Mg, Zn, Al, Ga, B, Zr, or Ti; 0≤x≤0.3; 0≤y≤0.5; 0≤z≤0.5; 0≤x″≤0.4; 0≤α≤1; 0≤β≤1; 0≤γ≤1; 0≤δ′≤0.4; and 0≤z″≤0.4. The cathode material may include lithium cobalt oxide (LiCoO₂), lithium nickel manganese oxide (LiMn_{0.5}Ni_{0.5}O₂ and/or LiNi_{0.5}Mn_{1.5}O₄), lithium nickel manganese cobalt oxide (LiMn_{1/3}Co_{1/3}Ni_{1/3}O₂ and/or LiNi_{0.8}Mn_{0.1}Co_{0.1}O₂ (NMC 811)), lithium nickel oxide (LiNiO₂), or any combination of two or more thereof. The cathode material may include LiNi₁₋ₓCo_{y}M⁴₂O₂, LiNiPO₄. In some embodiments, the cathode material preferably includes a material including nickel.

The battery cathode material may be in the form of a particulate material. The particulate material may have an average particle size of about 0.1 μm to about 1 mm, about 0.5 μm to about 100 μm, about 1 μm to about 10 μm, about 10 μm to about 50 μm, or about 50 μm to about 100 μm. For example, the average particle size may be about 1 μm, 5 μm, 10 μm, 20 μm, 30 μm, 40 μm, 50 μm, 60 μm, 70 μm, 80 μm, 90 μm, or 100 μm.

The battery cathode particulate material may be modified with CVT prior to forming a battery cathode. The battery cathode may be formed using a binder that holds the CVT-treated active material and other materials in the electrode to a current collector. Illustrative binders include, but are not limited to, polyvinylidene difluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), alginate, gelatin, a copolymer of any two or more such polymers, or a blend of any two or more such polymers.

Illustrative current collectors for the cathode may include those of indium-doped tin oxide, PET with indium-doped tin oxide, nickel, copper, stainless steel, titanium, tantalum, platinum, gold, aluminum, nickel, cobalt nickel alloy, highly alloyed ferritic stainless steel containing molybdenum and chromium, or nickel-, chromium-, or molybdenum-containing alloys.

The battery cathode may include a conductive additive. Illustrative conductive additives include synthetic graphite, natural graphite, amorphous carbon, hard carbon, soft carbon, acetylene black, mesocarbon microbeads (MCMB), carbon black, Ketjen® black, mesoporous carbon, porous carbon matrix, carbon nanotube, carbon nanofiber, or graphene.

Also disclosed herein are rechargeable lithium-ion batteries that include the cathodes modified with CVT. In addition to the modified cathode, the battery may also include a non-aqueous electrolyte and an anode.

Illustrative anodes include metallic anode active materials such as lithium; sulfur materials; metal oxides such as TiO₂ or Li₄Ti₅O₁₂; or carbon materials including, but not limited to, synthetic graphite, natural graphite, amorphous carbon, hard carbon, soft carbon, acetylene black, mesocarbon microbeads (MCMB), carbon black, Ketjen® black, mesoporous carbon, porous carbon matrix, carbon nanotube, carbon nanofiber, or graphene. In any of the above embodiments, the anode may include a graphite material, alloys, intermetallics, silicon, silicon oxides, TiO₂ and Li₄Ti₅O₁₂, and composites thereof. For example, the anode active material may include a lithium intercalated within a host material, where the host material may be an active carbon material including, but not limited to, synthetic graphite, natural graphite, amorphous carbon, hard carbon, soft carbon, acetylene black, mesocarbon microbeads (MCMB), carbon black, Ketjen® black, mesoporous carbon, porous carbon matrix, carbon nanotube, carbon nanofiber, or graphene.

The anode of the battery may also include a current collector. Current collectors for the anode may include those of indium-doped tin oxide, PET with indium-doped tin oxide, nickel, copper, stainless steel, titanium, tantalum, platinum, gold, aluminum, nickel, cobalt nickel alloy, highly alloyed ferritic stainless steel containing molybdenum and chromium, or nickel-, chromium-, or molybdenum-containing alloys.

The anode may include a binder that holds the active material and other materials in the electrode to the current collector. Illustrative binders include, but are not limited to, polyvinylidene difluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), alginate, gelatin, a copolymer of any two or more such polymers, or a blend of any two or more such polymers.

The battery may also include a separator between the cathode and anode to prevent shorting of the cell. Suitable separators include those such as, but not limited to, a microporous polymer film that is nylon, cellulose, nitrocellulose, polysulfone, polyacrylonitrile, polyvinylidene fluoride, polypropylene, polyethylene, polybutene, or a blend or copolymer thereof. In some embodiments, the separator is an electron beam treated micro-porous polyolefin separator. In some embodiments, the separator is a shut-down separator. Commercially available separators include those such as, but not limited to, Celgard® 2025 and 3501, Tonen separators, and ceramic-coated separators.

The non-aqueous electrolyte in the battery may include a non-aqueous solvent and a salt. Illustrative non-aqueous solvents include, but are not limited to, silanes, siloxanes, ethylene carbonate, dimethylcarbonate, diethylcarbonate, propylene carbonate, dioloxane, γ-butyrolactone, γ-butyrolactone, dimethyl ether, a silane, siloxane N-methyl acetamide, acetonitrile, an acetal, a ketal, esters, a carbonates, a sulfone, a sulfite, sulfolane, an aliphatic ether, a cyclic ether, a glyme, a polyether, a phosphate ester, a siloxane, a N-alkylpyrrolidone, fluoro ether and fluoro esters, fluoroethylene carbonate, or adiponitrile, or a fluorinated solvent. Illustrative fluorinated solvents include those represented by Formula I, II, III, or IV:

R¹—O—R² Formula I

R¹—C(O)O—R² Formula II

R¹—OC(O)O—R² Formula III

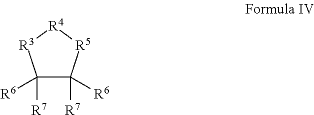

R¹—S(OO)—R² Formula V

In Formulas I, II, III, IV, and V, R¹ and R² are individually an alkyl or CₐH_{b}F_{c} group; R³ and R⁵ are individually O or CR⁶R⁷; R⁴ is O or C═O; each R⁶ and R⁷ is individually H, F or a CₐH_{b}F_{c} group; each b is individually from 0 to 2a; each c is individually from 1 to 2a+1; and each a is individually an integer from 1 to 20. However, the formulae are also subject to the following provisos: at least one of R¹ and R² is a CₐH_{b}F_{c} group; at least one R⁶ or R⁷ is other than H, and R⁴ is not O when R³ or R⁵ is O. In some embodiments, R¹ and R² are individually CF₂CF₃; CF₂CHF₂; CF₂CH₂F; CF₂CH₃; CF₂CF₂CF₃; CF₂CF₂CHF₂; CF₂CF₂CH₂F; CF₂CF₂CH₃; CF₂CF₂CF₂CF₃; CF₂CF₂CF₂CHF₂; CF₂CF₂CF₂CH₂F; CF₂CF₂CF₂CH₃; CF₂CF₂CF₂CF₂CF₃; CF₂CF₂CF₂CF₂CHF₂; CF₂CF₂CF₂CF₂CH₂F; CF₂CF₂CF₂CF₂CH₃; or CF₂CF₂OCF₃. In some embodiments, the fluorinated solvent includes CHF₂CF₂OCF₂CF₂CF₂H;

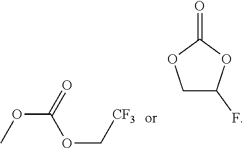

As noted, the non-aqueous electrolyte may include a non-aqueous solvent and a salt. The salt may be a salt as known for use in a lithium ion, sodium ion, magnesium ion, or other battery. For example, the salt may be a lithium salt. Suitable lithium salts include, but are not limited to, LiBr, LiI, LiSCN, LiBF₄, LiAlF₄, LiPF₆, LiAsF₆, LiClO₄, Li₂SO₄, LiB(Ph)₄, LiAlO₂, Li[N(FSO₂)₂], Li[SO₃CH₃], Li[BF₃(C₂F₅)], Li[PF₃(CF₂CF₃)₃], Li[B(C₂O₄)₂], Li[B(C₂O₄)F₂], Li[PF₄(C₂O₄)], Li[PF₂(C₂O₄)₂], Li[CF₃CO₂], Li[C₂F₅CO₂], Li[N(CF₃SO₂)₂], Li[C(SO₂CF₃)₃], Li[N(C₂F₅SO₂)₂], Li[CF₃SO₃], Li₂B₁₂X₁₂₋ₙHₙ, Li₂B₁₀X_{10-n′}H_{n′}, Li₂S_{x″}, (LiS_{x″}R¹)_{y}, (LiSe_{x″}R¹)_{y}, and lithium alkyl fluorophosphates; where X is a halogen, n is an integer from 0 to 12, n′ is an integer from 0 to 10, x″ is an integer from 1 to 20, y is an integer from 1 to 3, and R¹ is H, alkyl, alkenyl, aryl, ether, F, CF₃, COCF₃, SO₂CF₃, or SO₂F. In any of the above embodiments, the salt includes Li[B(C₂O₄)₂], Li[B(C₂O₄)F₂], LiClO₄, LiBF₄, LiAsF₆, LiPF₆, LiCF₃SO₃, Li[N(CF₃SO₂)₂], Li[C(CF₃SO₂)₃], Li[N(SO₂C₂F₅)₂], or a lithium alkyl fluorophosphate.

The present invention, thus generally described, will be understood more readily by reference to the following examples, which are provided by way of illustration and are not intended to be limiting of the present invention.

### Examples

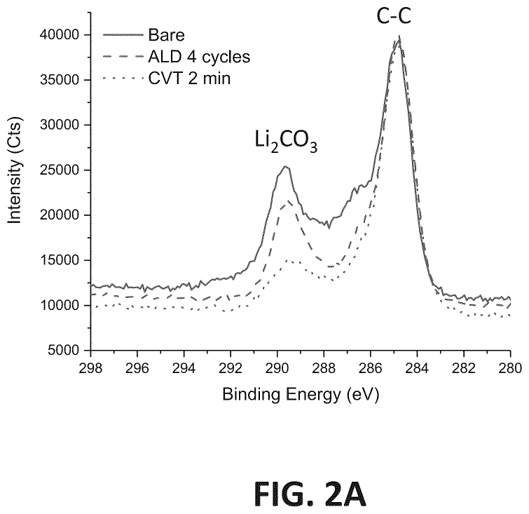

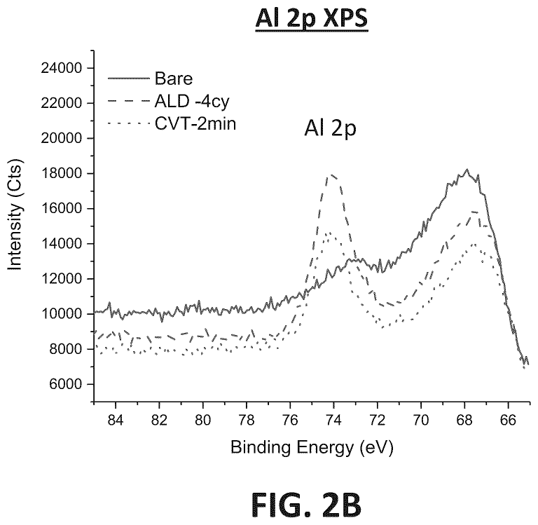

FIG. 2A is a graph of X-ray photoelectron spectroscopy (XPS) spectra showing the C-1s peak of cathode materials and FIG. 2B is a graph of XPS spectra showing the Al-2p peak of cathode materials. The cathode materials tested were a bare nickel-rich layered oxide LiNi_{0.8}Mn_{0.1}Co_{0.1}O₂ (NMC 811), NMC 811 modified with a CVT process, and NMC 811 coated with 4 cycles of Al₂O₃ atomic layer deposition (ALD). The CVT process included exposure with TMA for 2 minutes at 300° C., with a TMA partial pressure of about 0.2 Torr above a reactor base pressure of about 1.0 Torr. The specific surface area of the NMC 811 powder was about 1 m²/g.

The results in FIG. 2A showed a substantial reduction in the Li₂CO₃ peak in the NMC 811 treated with CVT, as compared to both the ALD-treated and bare NMC 811. In contrast, the C—C peak was unaffected by treatment with CVT or ALD. The results in FIG. 2B showed the presence of an Al-2p peak in the CVT treated NMC 811, indicating the formation of Al bonds on the surface of the NMC811.

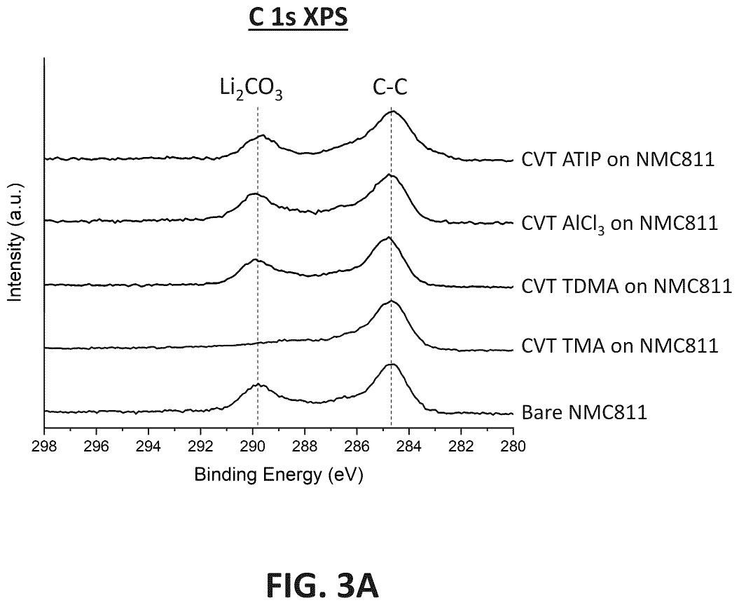

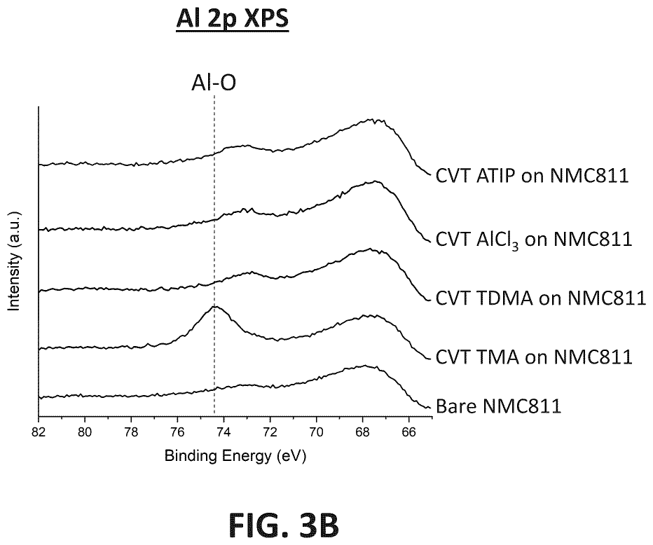

The results in FIG. 3A showed that the CVT process was effective with an alkyl-ligand precursor (trimethylaluminum, TMA). Other precursors, including tetrakis(dimethylamido) aluminum (TDMA), aluminum chloride (AlCl₃), and aluminum triisopropoxide (ATIP), did not reduce the Li₂CO₃ peak in the NMC treated with CVT as compared to bare NMC 811. The results in FIG. 3B showed the formation of an Al—O bonds in the CVT with TMA on NMC811 while other Al precursors (TDMA, AlCl₃, and ATIP) did not form Al—O bonds.

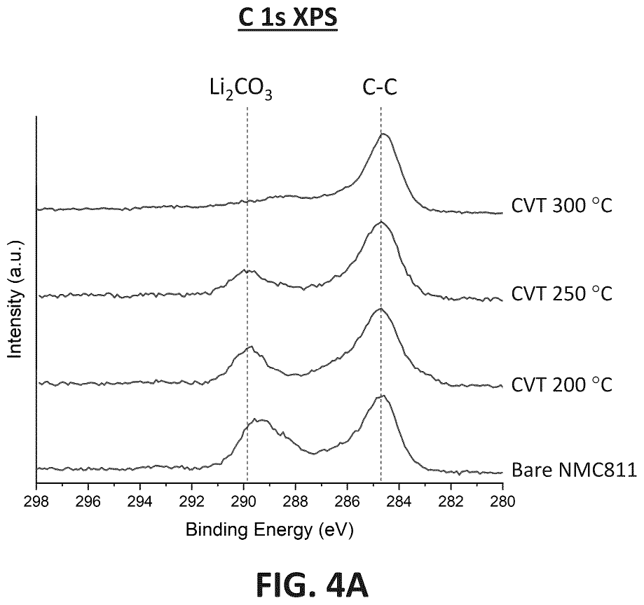

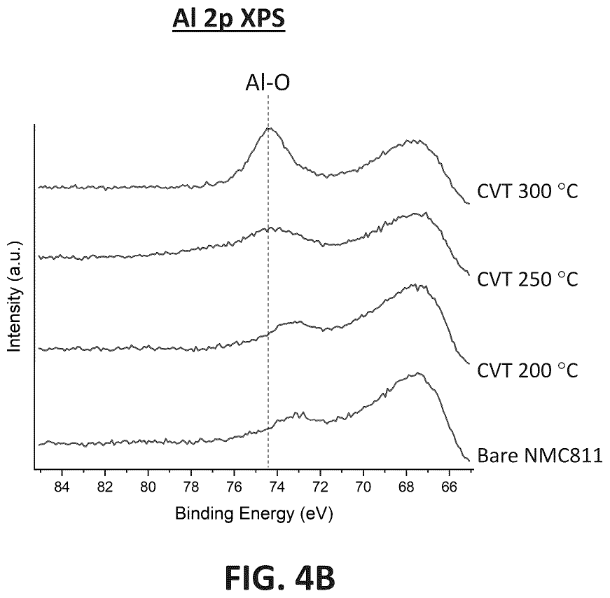

The results in FIG. 4A showed that the CVT process with an alkyl-ligand precursor (trimethylaluminum, TMA) was dependent on reaction temperature. The CVT process was conducted for 2 minutes at different temperatures. In the same time period, the CVT process was effective at higher temperatures. At lower temperatures, reduction of Li₂CO₃ on cathode materials was retarded. The results in FIG. 4B showed the formation of an Al—O bonds occurred faster at higher temperatures in the CVT with TMA on NMC811.

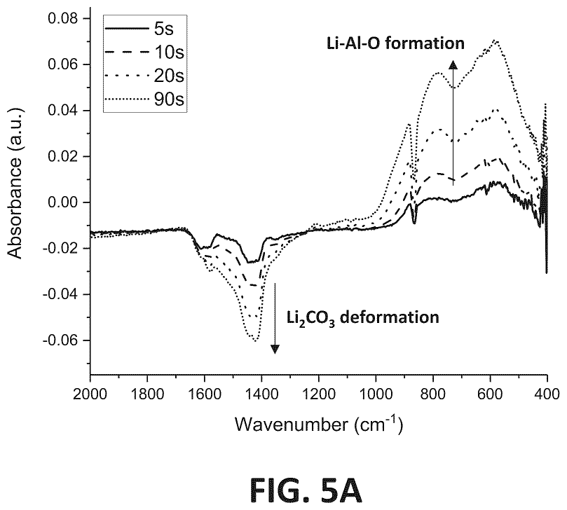

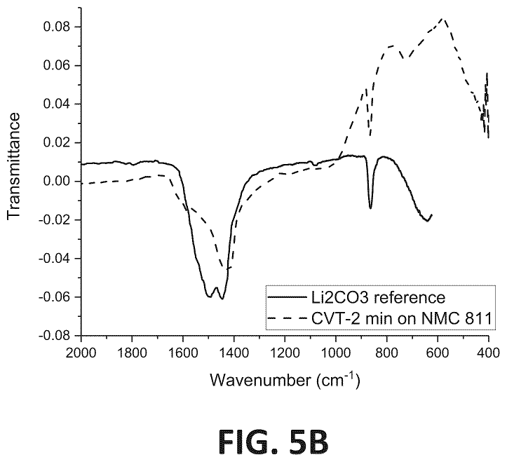

FIG. 5A is a graph of Fourier-transformed infrared (FTIR) spectra of NMC 811 modified with the CVT process using different exposure times of trimethylaluminum (TMA). The exposure times were 5 seconds, 10 seconds, 20 seconds, 30 seconds, 40 seconds, 60 seconds, and 90 seconds. FIG. 5B is a graph of FTIR spectra of NMC 811 modified by CVT with 90 seconds of TMA as compared to a Li₂CO₃ reference without TMA treatment. These data were collected at a temperature of 300° C.

The results in FIG. 5A indicated greater loss of Li₂CO₃ with increasing TMA exposure times, with the greater loss of Li₂CO₃ when the NMC 811 was exposed to 90 seconds of TMA. The results also indicated the formation of Li—Al—O with increasing TMA exposure times, with greater formation when the NMC 811 was exposed to 90 seconds of TMA.

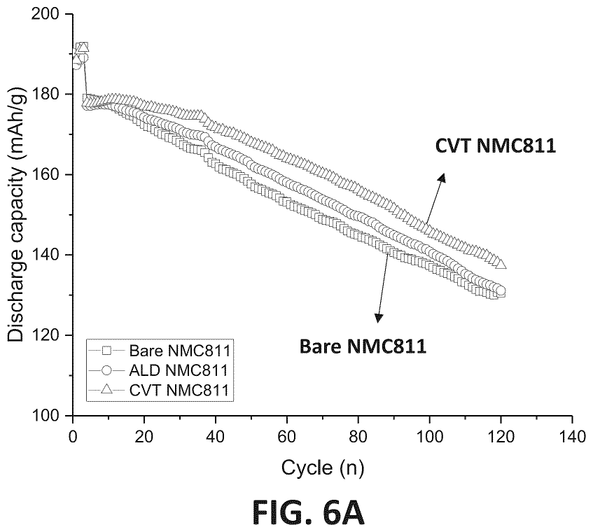

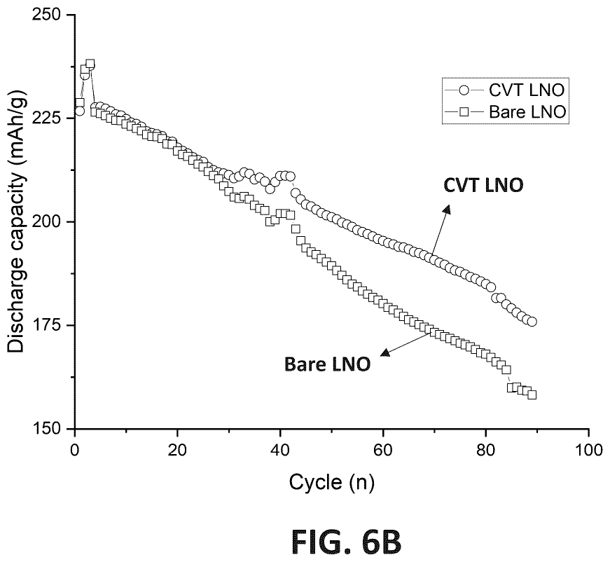

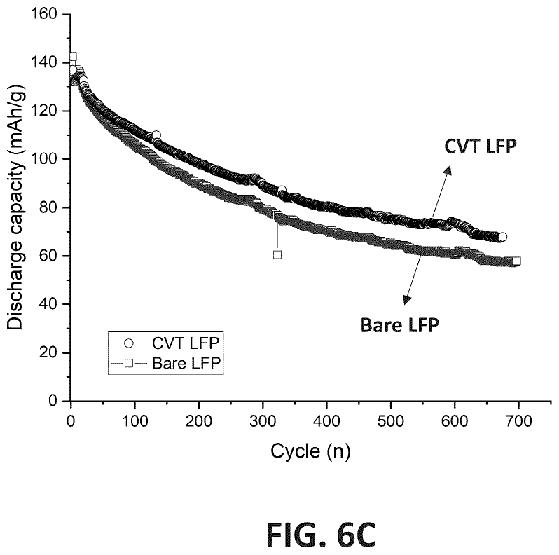

FIG. 6A is a graph of battery cycling of a NMC 811 cathode modified with the CVT process with TMA as compared to a bare, unmodified NMC811 cathode and an NMC 811 cathode coated with 4 cycles of Al₂O₃ ALD. CVT was conducted with a 2-minute exposure of TMA at 300° C. ALD was conducted using TMA and H₂O at 200° C., with the total deposition taking 20 minutes.

FIG. 6B is a graph of battery cycling of a lithium nickel oxide (LNO) cathode modified with the CVT process with TMA as compared to a bare, unmodified LNO cathode. CVT was conducted with a 2-minute exposure of TMA at 300° C. FIG. 6C is a graph of battery cycling of a lithium iron phosphate (LFP) modified with the CVT process with TMA as compared to a bare, unmodified LFP cathode. CVT was conducted with a 2-minute exposure of TMA at 300° C.

The battery included a lithium metal anode and an electrolyte containing 1.2 M LiPF₆ dissolved in ethylene carbonate:ethylmethyl carbonate (EC:EMC) 3:7 by weight. The first three electrochemical cycles were formation cycles conducted at 0.1 C, and the following cycles were conducted at 0.5 C for NMC811 and LNO, at 1 C for LFP, respectively.

The results in FIG. 6A indicated that the cathode with CVT-treated NMC 811 had consistently higher discharge capacity than cathodes with bare NMC 811 or NMC 811 treated with 4 cycles of Al₂O₃ ALD. This trend was consistent over 120 charge/discharge cycles. The results in FIG. 6B indicated that the cathode with CVT-treated LNO had consistently higher discharge capacity than cathodes with bare LNO. This trend was consistent over 90 charge/discharge cycles. The results in FIG. 6C indicated that the cathode with CVT-treated LFP had consistently higher discharge capacity than cathodes with bare LFP. This trend was consistent over 700 charge/discharge cycles.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation, or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method of modifying a battery cathode material, the method comprising:
heating the battery cathode material to a temperature of about 250° C. to about 350° C.;
while heating, exposing the battery cathode material to an organometallic gas; and
purging the organometallic gas from the battery cathode material.

2. The method of claim 1, wherein the battery cathode material comprises lithium carbonate prior to exposing the battery cathode material to the organometallic gas and the battery cathode material does not comprise the lithium carbonate after exposing the battery cathode material to the organometallic gas.

3. The method of claim 2, wherein exposing the battery cathode material to the organometallic gas comprises converting the lithium carbonate to a lithium metal oxide.

4. The method of claim 1, wherein exposing the battery cathode material to the organometallic gas comprises exposing the battery cathode material to the organometallic gas for about 10 seconds to about 5 minutes.

5. The method of claim 4, wherein exposing the battery cathode material to the organometallic gas comprises exposing the battery cathode material to the organometallic gas for about 2 minutes.

6. The method of claim 1, wherein the organometallic gas comprises an organoaluminum gas, an organoindium gas, an organogallium gas, an organozinc gas, an organocadmium gas, an organoniobium gas, an organotungsten gas, an organomolybdenum, an organotitanium gas, or a mixture of two or more thereof.

7. The method of claim 1, wherein the organometallic gas comprises an organoaluminum gas.

8. The method of claim 7, wherein the organoaluminum gas comprises trimethylaluminum.

9. The method of claim 1, wherein the organometallic gas comprises trimethylindium.

10. The method of claim 1, wherein the battery cathode material comprises lithium cobalt oxide, lithium nickel manganese cobalt oxide, lithium nickel oxide, or a mixture thereof.

11. The method of claim 1, wherein the battery cathode material is a powder.

12. The method of claim 1, wherein the method does not comprise exposing the battery cathode material to any co-reactant gas.

13. A battery cathode material having a conformal layer of lithium metal oxide on a surface of the battery cathode material.

14. The battery cathode material of claim 13, wherein the battery cathode material does not comprise lithium carbonate.

15. The battery cathode material of claim 13, wherein the battery cathode material comprises lithium cobalt oxide, lithium nickel manganese cobalt oxide, lithium nickel oxide, or a mixture thereof.

16. The battery cathode material of claim 13, wherein the lithium metal oxide comprises lithium aluminate, lithium indiumate, lithium gallium oxide, lithium zinc oxide, lithium cadmium oxide, lithium niobium oxide, lithium tungsten oxide, lithium molybdenum oxide, lithium titanium oxide, or a mixture of two or more thereof.

17. The battery cathode material of claim 13, wherein the battery cathode material is made by a process comprising:
heating the battery cathode material to a temperature of about 250° C. to about 350° C.;
while heating, exposing the battery cathode material to an organometallic gas; and
purging the organometallic gas from the battery cathode material.

18. The battery cathode material of claim 17, wherein the organometallic gas comprises an organoaluminum gas, an organoindium gas, an organogallium gas, an organozinc gas, an organocadmium gas, an organoniobium gas, an organotungsten gas, an organomolybdenum gas, an organotitanium gas, or a mixture of two or more thereof.

19. The battery cathode material of claim 17, wherein the organometallic gas comprises trimethylaluminum.
